(19) United States
(12) Patent Application Publication
(10) Pub. No.: US 2025/0270840 A1
(43) Pub. Date: Aug. 28, 2025

(54) Collapsible Tent Assembly

(71) Applicant: Travis Lonny Stucky, Mora, MN (US)

(72) Inventor: Travis Lonny Stucky, Mora, MN (US)

(21) Appl. No.: 18/589,074

(22) Filed: Feb. 27, 2024

(51) Int. Cl. E04H 15/06; B60P 3/34

(52) U.S. Cl. CPC E04H 15/06; B60P 3/34

(57) ABSTRACT

A collapsable tent assembly for constructing a climate-controlled shelter within an enclosure includes an enclosure having a ceiling, and a floor, and a plurality of sides that define an interior space. A plurality of braces extends between opposing lateral sides of the enclosure. A tent is positioned in the interior space of the enclosure. The tent is collapsable into a storage position, wherein the tent is positioned against one side of the plurality of sides of the enclosure. The tent is expandable into a deployed position wherein the tent defines a chamber within the interior space of the enclosure. A tent roof is slidably coupled to the plurality of braces. A plurality of tent walls is coupled to and extends downwardly from the tent roof toward the floor of the enclosure to define the chamber. A tent door is coupled to one of the plurality of tent walls.

### CROSS-REFERENCE TO RELATED APPLICATIONS

### Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tents and more particularly pertains to a new tent for constructing a climate-controlled shelter within an enclosure.

### (2) Description of Related Art Including Information Disclosed Under 37 CFR 1.97 and 1.98

The prior art relates to tents. The prior art discloses tents that can be easily set up and taken down in an outdoor space. For example, tents are often designed so that a pair of people, or even a single person, can quickly create shelter when staying in the outdoors. Insulated tents have been designed to keep the shelter comfortable even when the user is staying in cold climates, such as while the user is ice fishing. However, such tents typically have fabric or canvas walls that provide limited protection from cold winds which commonly gust across a frozen lake. Although the prior art discloses portable sheds that can be placed near the fishing location, those sheds are often expensive. Thus, there is a need for a more cost-affordable solution to finding warm and comfortable shelter near ice fishing locations. Ice fishers also often bring a trailer to the ice fishing location, to carry the tent and other gear needed during the fishing expedition. Typically, ice fishers need to choose between towing the trailer and the portable shed behind their vehicle. Thus, there is a need for a comfortable shelter that can be transported within the trailer, while the trailer is also being used to transport snowmobiles, provisions, fishing gear, and other equipment needed for the fishing expedition. In another example, a person may want to create a warm, climate-controlled area within their shed or garage. Prior art tents can be constructed within an immobile enclosure such as a shed or garage, but typically such tents are not designed to accommodate an adult standing up within the tent. Thus, there is a need for a climate-controlled tent that can be installed into an enclosure which allows the user to stand up within the tent area.

### BRIEF SUMMARY OF THE INVENTION

An embodiment of the disclosure meets the needs presented above by generally comprising an enclosure having a ceiling, and a floor, and a plurality of sides that is coupled to and extending between the ceiling and the floor to define an interior space of the enclosure. A plurality of braces is coupled to the enclosure. The plurality of braces extend between opposing lateral sides of the plurality of sides of the enclosure. A tent is coupled to the enclosure. The tent is positioned in the interior space of the enclosure. The tent is collapsable into a storage position. The tent is positioned against one side of the plurality of sides of the enclosure when the tent is in the storage position. The tent is expandable into a deployed position wherein the tent defines a chamber within the interior space of the enclosure when the tent is in the deployed position. A tent roof is slidably coupled to the plurality of braces. A plurality of tent walls is coupled to and extends downwardly from the tent roof toward the floor of the enclosure wherein the tent is configured to define the chamber. A tent door is coupled to a tent wall of the plurality of tent walls. The tent door is openable to facilitate access to the chamber. The tent comprises a fabric material. The fabric material is flexible wherein the fabric material configured to facilitate the tent being collapsed into the storage position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a collapsable tent assembly according to an embodiment of the disclosure.

FIG. 2 is a rear isometric view of an embodiment of the disclosure.

FIG. 3 is a rear isometric view of an embodiment of the disclosure.

FIG. 4 is a cross-sectional view of an embodiment of the disclosure.

FIG. 5 is a cross-sectional view of an embodiment of the disclosure.

FIG. 6 is a cross-sectional view of an embodiment of the disclosure.

FIG. 7 is a cross-sectional view of an embodiment of the disclosure.

FIG. 8 is a cross-sectional view of an embodiment of the disclosure.

FIG. 9 is a detail view of an embodiment of the disclosure.

FIG. 10 is a detailed isometric view of an embodiment of the disclosure.

FIG. 11 is a detail view of an embodiment of the disclosure.

### DETAILED DESCRIPTION OF THE INVENTION

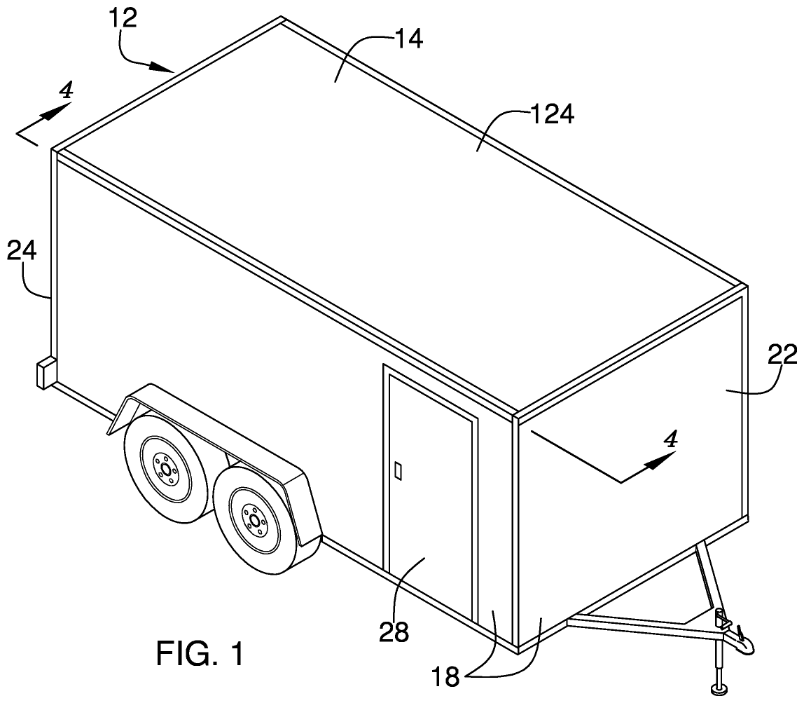

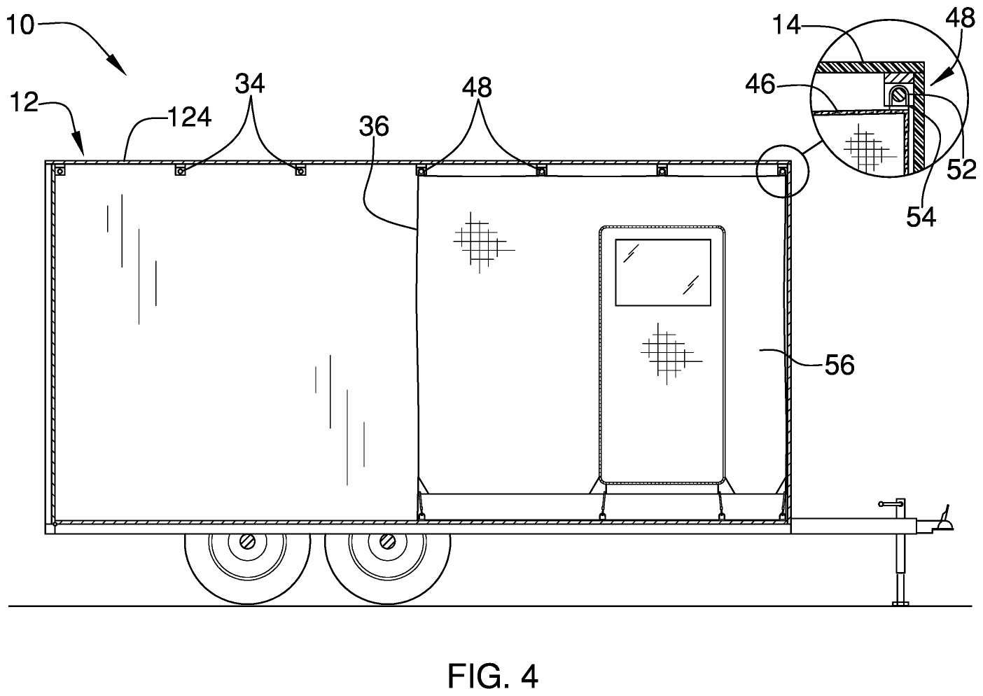

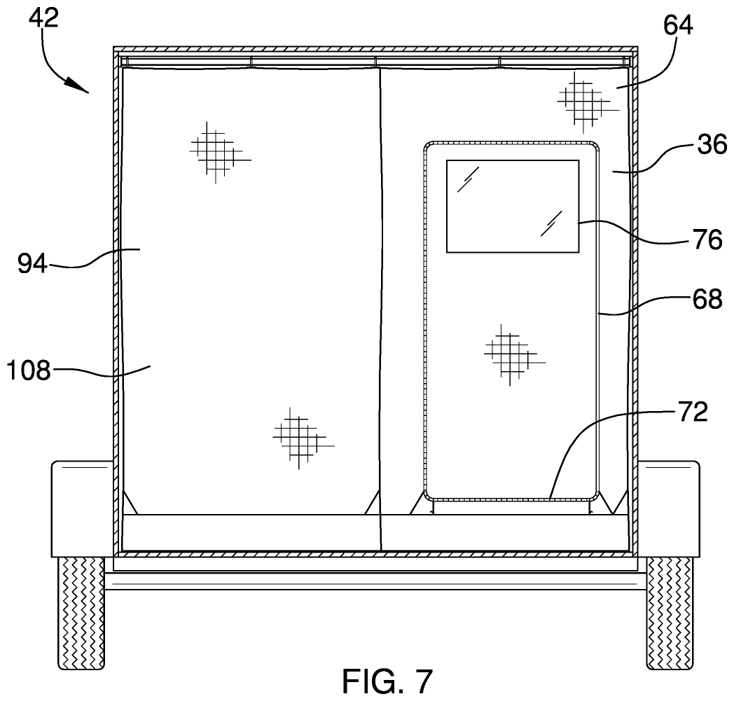

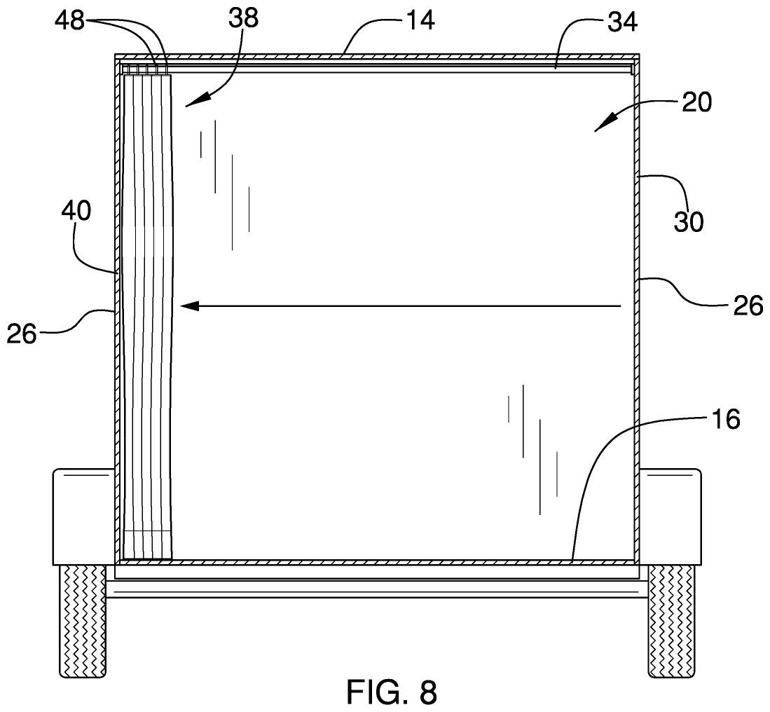

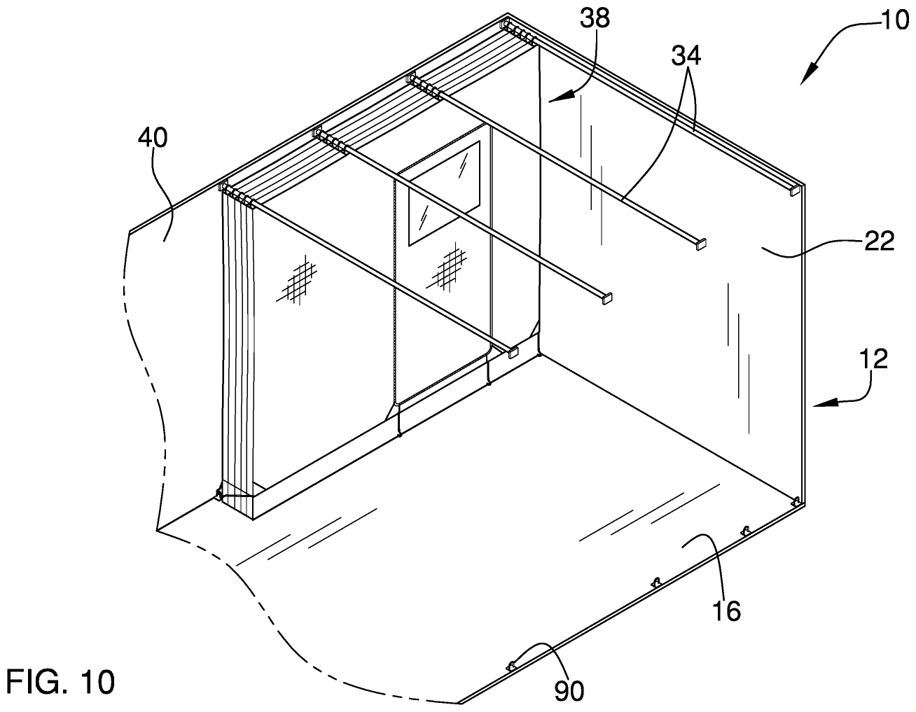

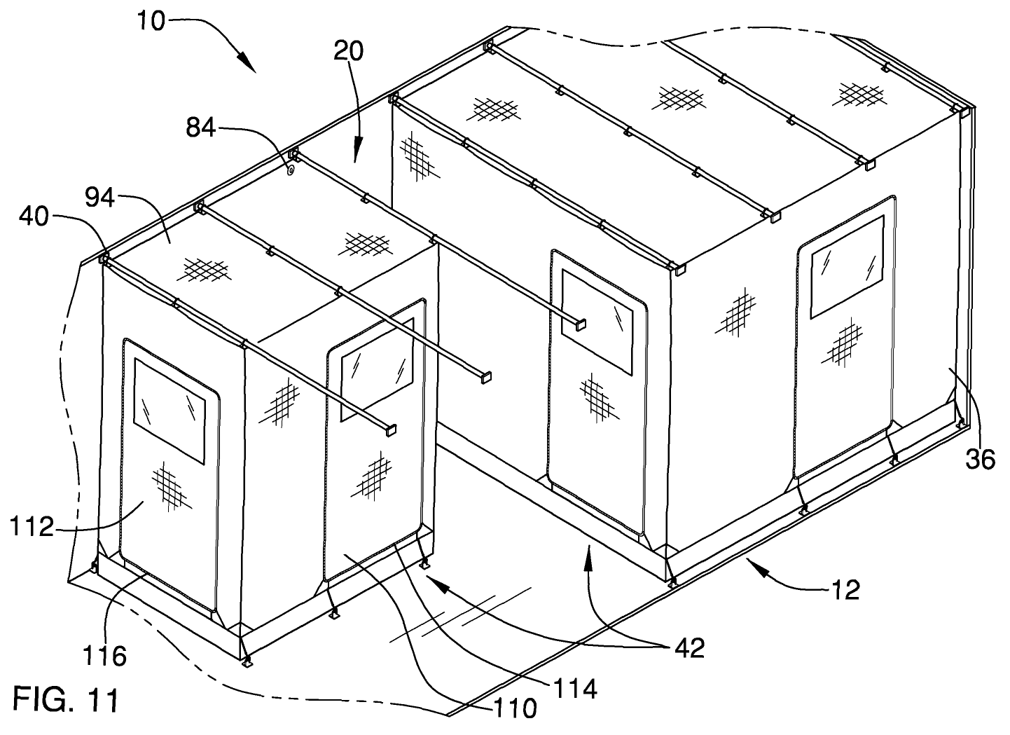

With reference now to the drawings, and in particular to FIGS. 1 through 11 thereof, a new tent embodying the principles and concepts of an embodiment of the disclosure and generally designated by the reference numeral 10 will be described.

As best illustrated in FIGS. 1 through 11, the collapsable tent assembly 10 generally comprises an enclosure 12 having a ceiling 14, a floor 16, and a plurality of sides 18. The plurality of sides 18 is coupled to and extends between the ceiling 14 and the floor 16 to define an interior space 20 of the enclosure 12. In other words, the enclosure 12 is enclosed. The plurality of sides 18 generally includes a front side 22, a back side 24, and a pair of lateral sides 26. The front side 22 and the back side 24 extend between opposing lateral edges of the pair of lateral sides 26. In some embodiments, such as those shown in the Figures, the enclosure 12 may comprise a trailer, such as an enclosed trailer. In other embodiments, the enclosure 12 may comprise a garage, a shed, or another enclosure in which the user wants to install the collapsable tent assembly 10.

A side-entry door 28 may be coupled to a first lateral side 30 of the pair of lateral sides 26. The side-entry door 28 is generally positioned proximate to the front side 22 of the enclosure 12. The side-entry door 28 is openable to facilitate access to the interior space 20.

A rear door 32 may be coupled to the back side 24 of the enclosure 12. The rear door 32 is openable to facilitate access to the interior space 20. When the enclosure 12 is a trailer, the rear door 32 may comprise a tailgate door which opens by pivoting downwardly from the ceiling 14.

A plurality of braces 34 is coupled to the enclosure 12. The plurality of braces 34 is positioned within the interior space 20 and is generally adjacent to the ceiling 14 of the enclosure 12. Each brace of the plurality of braces 34 is spaced from an adjacent brace of the plurality of braces 34, for example by between 1.5 feet and 2.5 feet. The plurality of braces 34 may extend between the pair of lateral sides 26 of the enclosure 12. In such embodiments, the plurality of braces 34 may be perpendicular to the pair of lateral sides 26 of the enclosure 12. Alternatively, the plurality of braces 34 may extend between the front side 22 and the back side 24 of the enclosure 12 and may be perpendicular to the front side 22 and the back side 24 of the enclosure 12. Examples of the plurality of braces 34 may comprise a rigid material, such as curtain rods or pipes. In other examples, the plurality of braces 34 may comprise a more flexible material, such as cables or ropes.

A tent 36 is coupled to the enclosure 12. The tent 36 is positioned in the interior space 20. For example, the tent 36 may be adjacent to the front side 22 of the enclosure 12. The tent 36 is collapsable into a storage position 38 wherein the tent 36 is positioned against a second lateral side 40 of the pair of lateral sides 26 of the enclosure 12 when the tent 36 is in the storage position 38. The tent 36 is expandable into a deployed position 42 wherein the tent 36 defines a chamber 44 within the interior space 20 of the enclosure 12 when the tent 36 is in the deployed position 42. In other words, the tent 36 may be pulled outwardly from the second lateral side 40 of the enclosure 12 into the deployed position 42, and the tent 36 may be pushed inwardly toward the second lateral side 40 of the enclosure 12 into the storage position 38.

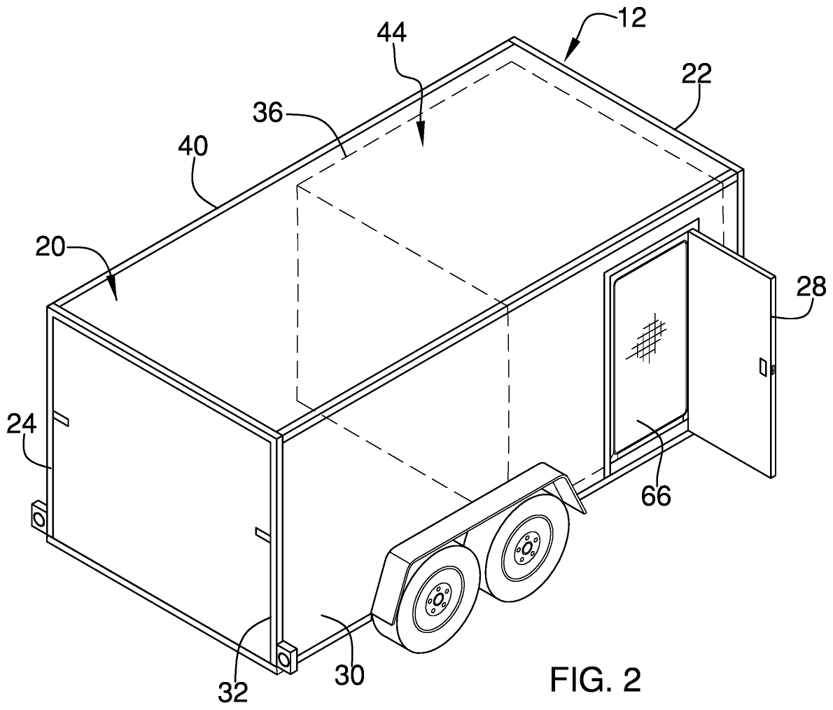

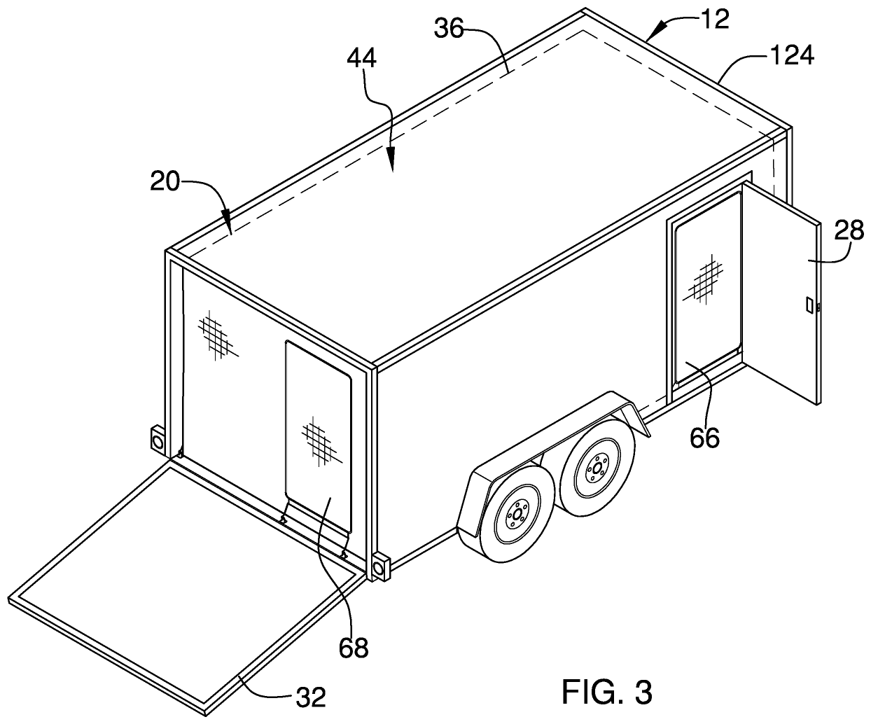

In some embodiments, the chamber 44 encompasses the entire interior space 20, as shown in FIG. 3. In other embodiments, the chamber 44 encompasses a portion of the interior space 20, as shown in FIG. 2. For example, the chamber 44 defined by the tent 38 may have a length between 9.0 feet and 11.0 feet and a width between 6.0 feet and 8.0 feet, depending on the dimensions of the enclosure 12. The plurality of braces 34 can be retrofitted into an existing enclosure 12, so a user can personalize the size of the chamber 44 to conform with the size of their existing enclosure 12 or to conform with the preferences of the user.

The tent 36 may further include a tent roof 46 that is slidably coupled to the plurality of braces 34 wherein the tent roof 46 is designed to slide along the plurality of braces 34 to facilitate transition of the tent 36 between the storage position 38 and the deployed position 42. The tent roof 46 may be rectangular to make efficient use of the interior space 20 of the enclosure 12, which is typically a cuboid. The tent roof 46 is generally positioned adjacent to the ceiling 14 of the enclosure 12 wherein the tent 36 is designed to permit the user to stand up within the chamber 44 when the tent 36 is in the deployed position 42.

A plurality of retainers 48 may slidably couple the tent roof 46 to the plurality of braces 34. For example, each retainer of the plurality of retainers 48 may include a curved portion 52 and a straight portion 54. The curved portion 52 is coupled to and extends between opposing lateral ends of the straight portion 54 wherein each retainer of the plurality of retainers 48 has a D-shape. The straight portion 54 is coupled to the tent roof 46 and the curved portion 52 hangs from a respective brace of the plurality of braces 34. For example, the plurality of retainers 48 may each comprise a D-ring. The plurality of retainers 48 may alternatively comprise loops of fabric coupled to the tent roof 46 or rollers that are coupled to the tent roof 48 for sliding the tent roof 48 along the plurality of braces 34. Such alternative embodiments may comprise alternative shapes or configurations which are designed to facilitate the tent roof 46 in sliding along each of the plurality of braces 34 between the storage position 38 and the deployed position 42.

A plurality of tent walls 56 is coupled to and extends downwardly from the tent roof 46 toward the floor 16 of the enclosure 12 wherein the tent 36 is designed to define the chamber 44. Each tent wall of the plurality of tent walls 56 is generally perpendicular to an adjacent tent wall of the plurality of tent walls 56 wherein the chamber 44 is rectangular, or a cuboid, when the tent 36 is in the deployed position 42.

The plurality of tent walls 56 may further include a first wall 58 that may be positioned adjacent to the second lateral side 40 of the pair of lateral sides 26 of the enclosure 12. The first wall 58 is generally parallel to the second lateral side 40 of the enclosure 12. The first wall 58 may remain in position adjacent to or against the second lateral side 40 of the pair of lateral sides 26 of the enclosure 12 when the tent 36 is in both the storage position 38 and the deployed position 42.

A second wall 60 is coupled to the first wall 58. The second wall 60 may be positionable proximate to the front side 22 of the enclosure 12 when the tent 36 is in the deployed position 42. The second wall 60 may be parallel to the front side 22 of the enclosure 12.

A third wall 62 is coupled to the second wall 60. The third wall 62 may be positionable against the first lateral side 30 of the pair of lateral sides 26 of the enclosure 12 when the tent 36 is in the deployed position 42. The third wall 62 is generally parallel to the first lateral side 30 of the enclosure 12 and to the first wall 58 of the plurality of tent walls 56.

A fourth wall 64 is coupled to the third wall 62 and the first wall 58. The fourth wall 64 may be parallel to the back side 24 of the enclosure 12 when the tent 36 is in the deployed position 42. The fourth wall 64 may be spaced from the back side 24 of the enclosure 12. The fourth wall 64 may be parallel to the second wall 60 of the plurality of tent walls 56.

A tent door is coupled to one of the plurality of tent walls 56 to facilitate access to the chamber 44. Embodiments include a side tent door 66 that may be coupled to the third wall 62 of the plurality of tent walls 56. The side tent door 66 is openable to facilitate access to the chamber 44. For example, the side tent door 66 may be aligned with the side-entry door 28 of the enclosure 12 wherein the side tent door 66 is designed to permit the user to enter the chamber 44 through the side-entry door 28 when the tent 36 is in the deployed position 42.

A back tent door 68 may be coupled to the fourth wall 64 of the plurality of tent walls 56. The back tent door 68 is openable to facilitate access to the chamber 44. For example, the back tent door 68 may be alignable with the rear door 32 of the enclosure 12 when the tent 36 is in the deployed position 42 wherein the back tent door 68 is designed to facilitate the user in entering the chamber 44 through the rear door 32 when the tent 36 is in the deployed position 42.

A side tent door fastener 70 is generally coupled to the third wall 62 of the plurality of tent walls 56 and to the side tent door 66. The side tent door fastener 70 secures the side tent door 66 to the third wall 62 of the plurality of tent walls 56 to inhibit the side tent door 66 from being opened. For example, the side tent door fastener 70 may include a zipper or a hook and loop material.

A back tent door fastener 72 may be coupled to the fourth wall 64 of the plurality of tent walls 56 and to the back tent door 68. The back tent door fastener 72 secures the back tent door 68 to the fourth wall 64 of the plurality of tent walls 56 to inhibit the back tent door 68 from being opened. For example, the back tent door fastener 72 may include a zipper or a hook and loop material.

A skirting 92 may be coupled to the plurality of tent walls 56. The skirting 92 extends downwardly from each tent wall of the plurality of tent walls 56 wherein a combined height of the skirting 92 and the plurality of tent walls 56 exceeds a height of the plurality of tent walls 56. The combined height of the skirting 92 and the plurality of tent walls 56 may also exceed a height of the enclosure 12 wherein the tent 36 is configured to extend between the ceiling 14 and the floor 16 of the enclosure 12 regardless of the height of the enclosure 12. Because the tent 36 may be retrofitted into an existing enclosure 12, the skirting 92 ensures the tent 36 will fit properly within the enclosure 12. If the skirting 92 is not needed, the skirting 92 may be rolled up against each tent wall of the plurality of tent walls 56 for storage, wherein rolling up the skirting is configured to inhibit the user from stepping on the skirting 92 as the user moves around the chamber 44. A releasable coupler, such as hook and loop material or a clip, can couple the skirting 92 to each tent wall of the plurality of tent walls 56 when the skirting 92 is rolled up, so that the skirting 92 is held off the floor 16 and out of the way.

A side tent door window 74 may be positioned on the side tent door 66. The side tent door window 74 is transparent wherein the side tent door window 74 is designed to facilitate the user in looking through the side tent door window 74.

A back tent door window 76 may be positioned on the back tent door 68. The back tent door window 76 is transparent wherein the back tent door window 76 is designed to facilitate the user in looking through the back tent door window 76.

A wall window 78 may be positioned on the fourth wall 64 of the plurality of tent walls 56. The wall window 78 is transparent wherein the wall window 78 is designed to facilitate the user in looking through the side wall window 78.

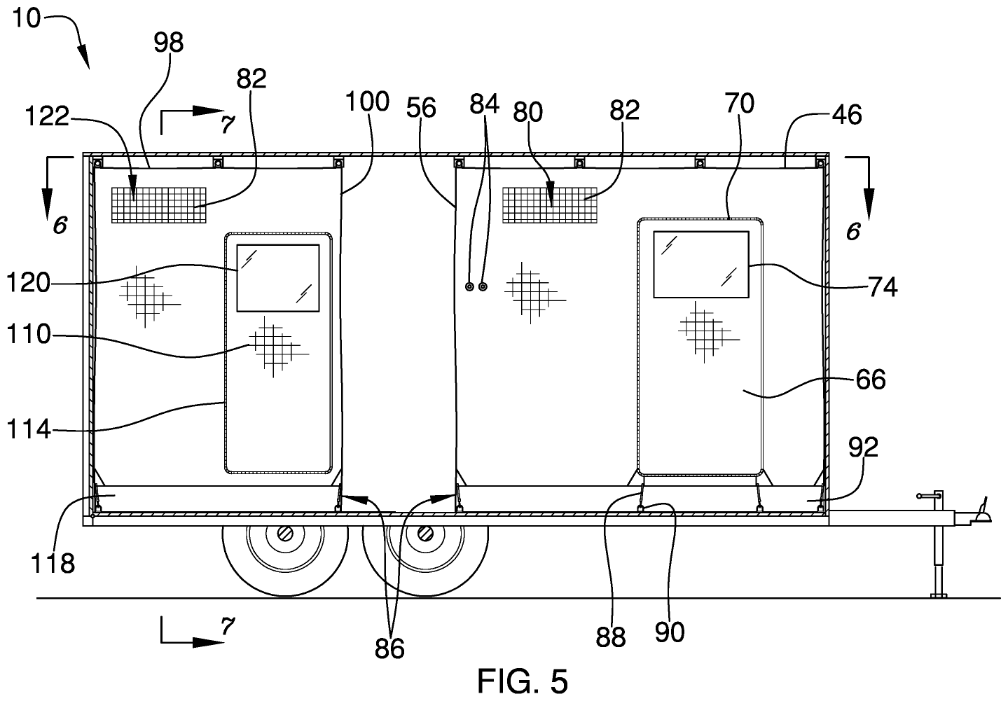

A vent 80 may extend through one or more of the plurality of tent walls 56 wherein the vent 80 is designed to facilitate airflow through the chamber 44. For example, the vent 80 may be positioned on the third wall 62, as shown in FIG. 5, or the fourth wall 64 because the third wall 62 of the tent 36 is aligned with the side-entry door 28 of the enclosure 12 and the fourth wall 64 of the tent 36 is aligned with the rear door 32 of the enclosure 12. Positioning the vent 80 on one or more of the plurality of tent walls 56 that are aligned with the side-entry door 28 or the rear door 32 of the enclosure 12 may efficiently facilitate airflow through the chamber 44 and the enclosure 12, particularly when the side-entry door 28 and the rear door 32 are opened.

A mesh fabric 82 may cover the vent 80. For example, the mesh fabric 82 may be foraminous wherein the mesh fabric 82 is configured to permit airflow through the vent 80 and to inhibit solid objects, such as debris or small animals, from entering the chamber 44 through the vent 80.

A plurality of through-holes 84 may extend through a respective wall of the plurality of tent walls 56. The plurality of through-holes 84 may making the respective wall of the plurality of walls designed to facilitate the user in hanging objects on the respective wall of the plurality of tent walls 56. For example, the plurality of through-holes 84 may be aligned with apertures or anchor holes extending into one of the plurality of sides 18 of the enclosure for hanging a coat hook or mounting a shelf so that the user has storage within the chamber 44.

In certain embodiments, the plurality of through-holes 84 may be positioned on the first wall 58 and align with apertures or anchor holes extending into the second lateral side 40 of the enclosure 12 because the first wall 58 can remain positioned against the second lateral side 40 of the enclosure 12 whether the tent 36 is in the storage position 38 or the deployed position 42. In other words, the tent 36 may expand outwardly from the second lateral side 40 of the enclosure 12 and collapse inwardly toward the second lateral side 40 of the enclosure 12. Positioning the plurality of through-holes 84 on the first wall 58 of the tent 36 may be preferred to permit the coat hook, mounting shelf, or other objects being hung on the first wall 58 may remain in position regardless of whether the tent 36 is collapsed into the storage position 38, expanded into the deployed position 42, or transitioning between the two positions.

In other embodiments, the plurality of through-holes 84 may be positioned on the tent roof 46, to facilitate the user in hanging objects from the ceiling 14 and the tent roof 46.

The tent roof 46, each of the plurality of tent walls 56, the side tent door 66, the back tent door 68, and the skirting 92 of the tent 36 typically including a fabric material. The fabric material is generally flexible wherein the fabric material designed to facilitate the tent 36 being collapsed into the storage position 38. The fabric material may be insulated wherein the fabric material is designed to insulate contents of the chamber 44 from outside temperatures. For example, the fabric material may insulate contents of the chamber 44 from temperatures outside of the enclosure 12, for example when the enclosure 12 is parked outdoors during cold weather. In such situations, the user may put a space heater into the chamber 44, to increase temperatures within the chamber 44 without needing to increase the temperature of the entire interior space 20 of the enclosure 12. Because the fabric material of the tent 36 is insulated, the chamber 44 may remain warm even if the enclosure 12 is not insulated. Alternatively, when the enclosure 12 is parked somewhere with hot outside temperatures, the user may put a fan inside the chamber 44 to cool down the temperature within the chamber 44 without needing to reduce the temperature of the entire interior space 20 of the enclosure 12. The fabric material is thus designed to facilitate climate control within the chamber 44. In other embodiments, the fabric material may not be insulated, for example comprising a mesh material that is configured to inhibit bugs and other pests from accessing the chamber 44. Such embodiments may be useful when the enclosure 12 is parked somewhere with a comfortable, temperate outdoor climate that the user wants to enjoy within the tent 36.

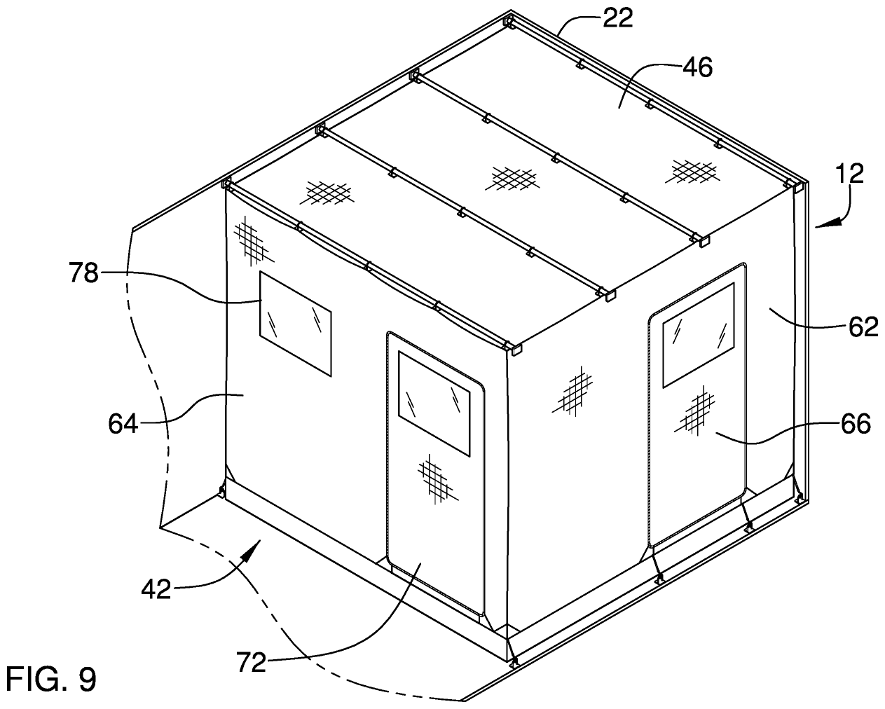

A plurality of anchors 86 may secure the plurality of tent walls 56 to the floor 16 of the enclosure 12. The plurality of anchors 86 may be engaged when the tent 36 is in the deployed position 42 to inhibit the plurality of tent walls 56 from moving away from the floor 16 of the enclosure 12. For example, the plurality of anchors 86 may retain the plurality of tent walls 56 in position relative to the floor 16 when the side-entry door 28 or the rear door 32 of the enclosure 12 is opened and wind gusts through the enclosure 12. The plurality of anchors 86 may be positioned proximate to junctions between each of the plurality of tent walls 56, as shown in FIG. 9. The plurality of anchors 86 may also be positioned adjacent to the side tent door 66 and the back tent door 68.

Embodiments of the plurality of anchors 86 may further include a plurality of straps 88 that is coupled to the plurality of tent walls 56. One or more straps of the plurality of straps 88 may be positioned on each wall of the plurality of tent walls 56. The plurality of straps 88 may extend downwardly from the plurality of tent walls 56. Each strap of the plurality of straps 88 may have an adjustable length wherein the plurality of straps 88 is designed to extend downwardly to the floor 16 regardless of the height of the enclosure 12. A plurality of tie-down rings 90 is coupled to the floor 16 of the enclosure 12. The plurality of straps 88 is aligned with the plurality of tie-down rings 90 when the tent 36 is in the deployed position 42 wherein each strap of the plurality of straps 88 is selectively engageable to an associated tie-down ring of the plurality of tie-down rings 90.

A secondary tent 94 may also coupled to the enclosure 12. The secondary tent 94 is very similar to the tent 36, except that the secondary tent 94 may be smaller than the tent 36 in certain embodiments. The secondary tent 94 generally defines a shelter compartment 94 within the interior space 20 of the enclosure 12. The shelter compartment 94 may have a volume that is less than a volume of the chamber 44 that is defined by the tent 36 wherein the shelter compartment 94 is designed to provide a bathroom or a closet space for the user.

The secondary tent 94 is collapsable into the storage position 38. For example, the secondary tent 94 may be positioned against the second lateral side 40 of the pair of lateral sides 26 of the enclosure 12 when the secondary tent 94 is in the storage position 38. The secondary tent 94 is expandable into the deployed position 42 wherein the secondary tent 94 defines the shelter compartment 94 within the interior space 20 of the enclosure 12 when the secondary tent 94 is in the deployed position 42.

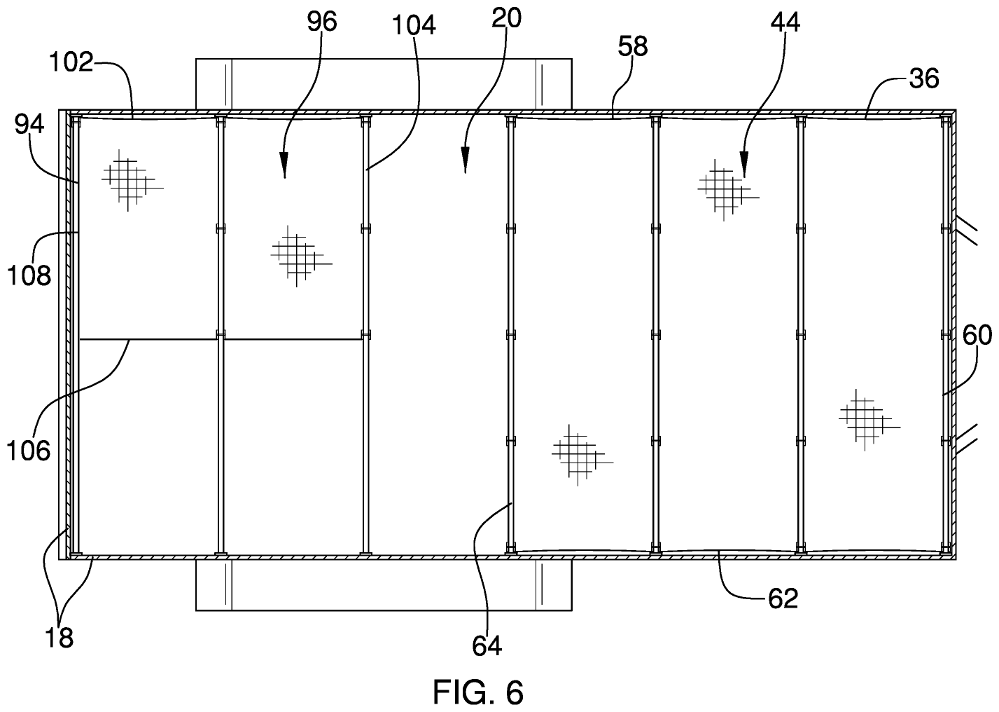

The secondary tent 94 is positioned in the interior space 20 of the enclosure 12, for example proximate to the back side 24 of the enclosure 12. The secondary tent 94 may be positioned between the back side 24 of the enclosure 12 and the tent 36, as shown in FIGS. 5 and 6. In alternative embodiments, the secondary tent 94 may be positioned between the front side 22 of the enclosure 12 and the tent 36.

The secondary tent 94 may further include a top panel 98 that is slidably coupled to the plurality of braces 34 wherein the top panel 98 is designed to slide along the plurality of braces 34 to facilitate transition of the secondary tent 94 between the storage position 38 and the deployed position 42. The plurality of retainers 48 may slidably couple the top panel 98 to the plurality of braces 34.

A plurality of side panels 100 is coupled to and extends downwardly from the top panel 98. Each side panel of the plurality of side panels 100 may be perpendicular to an adjacent panel of the plurality of side panels 100 wherein the shelter compartment 94 is rectangular, or a cuboid, when the secondary tent 94 is in the deployed position 42. Each side panel of the plurality of side panels 100 is generally parallel to a respective tent wall of the plurality of tent walls 56 when the secondary tent 94 and the tent 36 are each in the deployed position 42.

The plurality of side panels 100 may further include a primary panel 102 that is positioned adjacent to the second lateral side 40 of the pair of lateral sides 26 of the enclosure 12. The primary panel 102 may be parallel to the second lateral side 40 of the enclosure 12. The primary panel 102 may be aligned with the first wall 58 of the tent 36.

A secondary panel 104 may be coupled to the primary panel 102. The secondary panel 104 may be alignable with the front side 22 of the enclosure 12 when the secondary tent 94 is in the deployed position 42. The secondary panel 104 may be parallel to the front side 22 of the enclosure 12 when the secondary tent 94 is in the deployed position 42. The secondary panel 104 may be aligned with the second wall 60 of the tent 36. The secondary panel 104 is spaced from the second wall 60 of the tent 36.

A tertiary panel 106 is coupled to the secondary panel 104. The tertiary panel 106 may be positionable against the first lateral side 30 of the pair of lateral sides 26 of the enclosure 12 when the secondary tent 94 is in the deployed position 42. Alternatively, the tertiary panel 106 may be parallel to the first lateral side 30 of the enclosure 12 and spaced from the first lateral side 30 of the enclosure, as shown in FIG. 6. The tertiary panel 106 is generally parallel to the third wall 62 of the tent 36.

A quaternary panel 108 is coupled to the tertiary panel 106 and the primary panel 102. The quaternary panel 108 may be parallel to the back side 24 of the enclosure 12 when the secondary tent 94 is in the deployed position 42. The quaternary panel 108 may be aligned with the back side 24 of the enclosure 12 when the secondary tent 94 is in the deployed position 42. The quaternary panel 108 may be spaced from the back side 24 of the enclosure 12. The quaternary panel 108 may be parallel to the fourth wall 64 of the tent 36. The quaternary panel 108 is generally spaced from the fourth wall 64 of the tent 36.

Each panel of the plurality of side panels 100 may have a width that is smaller than a width of the plurality of tent walls 56 whereby the volume of shelter compartment 94 defined by the secondary tent 94 is less than the volume of the chamber 44 defined by the tent 36. More specifically, the width of each of the plurality of side panels 100 is measured as the distance between the two adjacent side panels of the plurality of side panels 100. The width of each of the plurality of tent walls 56 is similarly measured as the distance between the two adjacent tent walls of the plurality of tent walls 56. As an example, the width of the secondary panel 104 may be measured as the distance between the primary panel 102 and the tertiary panel 106, and the width of the second wall 60 may be measured as the distance between the first wall 58 and the third wall 62.

A side entryway 110 may be positioned on the tertiary panel 106 of the plurality of side panels 100. The side entryway 110 is openable to facilitate access to the shelter compartment 94 through the side-entry door 28 of the enclosure 12 when the secondary tent 94 is in the deployed position 42.

A back entryway 112 may be positioned on the quaternary panel 108 of the plurality of side panels 100. The back entryway 112 is openable to facilitate access to the shelter compartment 94 through the rear door 32 of the enclosure 12 when the secondary tent 94 is in the deployed position 42.

A side entryway fastener 114 may be coupled to the tertiary panel 106 of the plurality of side panels 100 and to the side entryway 110. The side entryway fastener 114 secures the side entryway 110 to the tertiary panel 106 to inhibit the side entryway 110 from being opened. For example, the side entryway fastener 114 may include a zipper or a hook and loop material.

A back entryway fastener 116 may be coupled to the quaternary panel 108 of the plurality of side panels 100 and to the back entryway 112. The back entryway fastener 116 secures the back entryway 112 to the quaternary panel 108 to inhibit the back entryway 112 from being opened. For example, the back entryway fastener 116 may include a zipper or a hook and loop material.

A trim 118 may be coupled to the plurality of side panels 100. The trim 118 extends downwardly from each side panel of the plurality of side panels 100 wherein a combined height of the trim 118 and the plurality of side panels 100 exceeds a height of the plurality of side panels 100. The combined height of the trim 118 and the plurality of side panels 100 may exceed the height of the enclosure 12 such that the secondary tent 94 extends between the ceiling 14 and the floor 16 of the enclosure 12 regardless of the height of the enclosure 12.

A window panel 120 may be coupled to the side entryway 110. The window panel 120 generally includes the transparent material wherein the window panel 120 is designed to facilitate the user in looking through the window panel 120. The window panel 120 may also be positioned on one of the plurality of side panels 100.

A cutout 122 may extending through one of the plurality of side panels 100. The cutout 122 is designed to facilitate airflow through the shelter compartment 94. For example, as shown in FIG. 5, the cutout 122 may extend through the tertiary panel 106 and may be positioned above the side entryway 110.

The mesh fabric 82 may cover the cutout 122 to permit airflow through the cutout 122 while inhibiting solid objects from entering the shelter compartment 94 through the cutout 122.

The plurality of through-holes 84 may extend through one or more panel of the plurality of side panels 100 of the secondary tent 94 so that the user can hang objects from one of the plurality of sides 18 of the enclosure 12 within the secondary tent 94. The plurality of through-holes 84 may also extend through the top panel 98 so that the user can hang objects from the ceiling 14 of the enclosure 12 within the secondary tent 94.

The top panel 98, the plurality of side panels 100, the side entryway 110, the back entryway 112, and the trim 118 of the secondary tent 94 generally include the fabric material. As stated above regarding the tent 36, the fabric material is flexible wherein the fabric material is designed to facilitate the secondary tent 94 being collapsed into the storage position 38. The fabric material is insulated wherein the fabric material is designed to insulate contents of the shelter compartment 94 from outside temperatures and to facilitate climate control within the shelter compartment 94.

The plurality of anchors 86 may securing the plurality of side panels 100 to the floor 16 of the enclosure 12 when the secondary tent 94 is in the deployed position 42.

In use, the plurality of braces 34 may be installed into a new enclosure 12 or retrofitted into an existing enclosure 12. For example, the plurality of braces 34 may be installed or retrofitted into an enclosure 12 that is mobile, such as the trailer 124 that is shown in FIGS. 1-4. Alternatively, the plurality of braces 34 may be installed or retrofitted into an enclosure 12 that is immobile, such as a shed or garage, as shown in FIGS. 9-11. The tent 36 slides along the plurality of braces 34 between the storage position 38 and the deployed position 42. By adjusting the positioning of the plurality of braces 34 along the ceiling 14 of the enclosure 12, the user can customize the dimensions of both the tent 36 and the secondary tent 94.

Because the tent 36 comprises the fabric material, the user may also adjust the size of the chamber 44 by only pulling the tent 36 partially along the plurality of braces 34. The secondary tent 94 slides along the plurality of braces 34 in the same manner as the tent 36. The insulated fabric material will facilitate climate control within the chamber 44 and the shelter compartment 96, without requiring control of the climate within the entire interior space 20 of the enclosure 12. When the tent 36 and the secondary tent 94 are not being used, they can each be pushed up against one of the plurality of sides 18 of the enclosure 12 in the storage position 38. The user can thus use the interior space 20 of the enclosure 12 for normal transport and storage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tent system comprising:
an enclosure having a ceiling, a floor, and a plurality of sides being coupled to and extending between the ceiling and the floor to define an interior space of the enclosure;
a plurality of braces being coupled to the enclosure, the plurality of braces extending between opposing lateral sides of the plurality of sides of the enclosure;
a tent being coupled to the enclosure, the tent being positioned in the interior space of the enclosure, the tent being collapsable into a storage position wherein the tent is positioned against one side of the plurality of sides of the enclosure when the tent is in the storage position, the tent being expandable into a deployed position wherein the tent defines a chamber within the interior space when the tent is in the deployed position, the tent further comprising:
a tent roof being slidably coupled to the plurality of braces;
a plurality of tent walls being coupled to and extending downwardly from the tent roof toward the floor of the enclosure wherein the tent is configured to define the chamber;
a tent door being coupled to a tent wall of the plurality of tent walls, the tent door being openable to facilitate access to the chamber; and
the tent comprising a fabric material, the fabric material being flexible wherein the fabric material configured to facilitate the tent being collapsed into the storage position.

2. The tent system of claim 1, further comprising a plurality of retainers slidably coupling the tent roof to the plurality of braces.

3. The tent system of claim 2, each retainer of the plurality of retainers further comprising a curved portion and a straight portion, the curved portion being coupled to and extending between opposing lateral ends of the straight portion wherein the straight portion is coupled to the tent roof and the curved portion is configured to hang from a respective brace of the plurality of braces.

4. The tent system of claim 1, further comprising:
the plurality of sides of the enclosure including a front side, a back side, and a pair of lateral sides; and
a side-entry door being coupled to a first lateral side of the pair of lateral sides of the enclosure, the side-entry door being openable to facilitate access to the interior space of the enclosure, wherein the tent is positioned against a second lateral side of the pair of lateral sides when the tent is in the storage position, and wherein the tent door is aligned with the side-entry door when the tent is in the deployed position.

5. The tent system of claim 4, the plurality of tent walls further comprising:
a first wall being positioned adjacent to the second lateral side of the pair of lateral sides of the enclosure;
a second wall being coupled to the first wall, the second wall being parallel to the front side of the enclosure when the tent is in the deployed position;
a third wall being coupled to the second wall, the third wall being parallel to the first lateral side of the enclosure, the tent door being positioned on the third wall; and
a fourth wall being coupled to the third wall and the first wall, the fourth wall being parallel to the back side of the enclosure when the tent is in the deployed position.

6. The tent system of claim 5, further comprising a back tent door being coupled to the fourth wall of the plurality of tent walls, the back tent door being openable to facilitate access to the chamber, the back tent door being alignable with a rear door on the back side of the enclosure when the tent is in the deployed position wherein the back tent door is configured to facilitate the user in entering the chamber through the rear door of the enclosure when the tent is in the deployed position.

7. The tent system of claim 6, further comprising:
a tent door fastener being coupled to the third wall of the plurality of tent walls and to the tent door, the side tent door fastener securing the tent door to the third wall of the plurality of tent walls to inhibit the tent door from being opened; and
a back tent door fastener being coupled to the fourth wall of the plurality of tent walls and to the back tent door, the back tent door fastener securing the back tent door to the fourth wall of the plurality of tent walls to inhibit the back tent door from being opened.

8. The tent system of claim 1, further comprising
the plurality of sides of the enclosure including a front side, a back side, and a pair of lateral sides; and
a rear door being coupled to the back side of the enclosure, the rear door being openable to facilitate access to the interior space of the enclosure, wherein the tent door is aligned with the rear door when the tent is in the deployed position.

9. The tent system of claim 1, wherein the plurality of sides of the enclosure includes a front side, a back side, and a pair of lateral sides, the plurality of braces extending between the pair of lateral sides of the enclosure.

10. The tent system of claim 9, wherein each brace of the plurality of braces is perpendicular to the pair of lateral sides of the enclosure.

11. The tent system of claim 1, further comprising a tent door fastener being coupled to the tent wall of the plurality of tent walls and to the tent door, the side tent door fastener securing the tent door to the tent wall of the plurality of tent walls to inhibit the tent door from being opened.

12. The tent system of claim 1, wherein the fabric material of the tent is insulated wherein the fabric material is configured to insulate contents of the chamber from temperatures within the interior space of the enclosure.

13. The tent system of claim 1, further comprising a skirting being coupled to the plurality of tent walls, the skirting extending downwardly from each tent wall of the plurality of tent walls wherein a combined height of the skirting and the plurality of tent walls exceeds a height of the plurality of tent walls, the combined height of the skirting and the plurality of tent walls exceeding a height of the enclosure.

14. The tent system of claim 1, further comprising a window being positioned on one of the plurality of tent walls.

15. The tent system of claim 1, further comprising a plurality of anchors securing the plurality of tent walls to the floor of the enclosure when the tent is in the deployed position.

16. The tent system of claim 15, each anchor of the plurality of anchors further comprising:
a plurality of straps being coupled to the plurality of tent walls, the plurality of straps extending downwardly from the plurality of tent walls;
a plurality of tie-down rings being coupled to the floor of the enclosure; and
the plurality of straps being aligned with the plurality of tie-down rings when the tent is in the deployed position wherein each strap of the plurality of straps is selectively engageable to an associated tie-down ring of the plurality of tie-down rings;

17. The tent system of claim 1, further comprising a secondary tent being coupled to the enclosure, the secondary tent being collapsable into the storage position wherein the secondary tent is positioned against one side of the plurality of sides of the enclosure when the secondary tent is in the storage position, the secondary tent being expandable into the deployed position wherein the secondary tent defines a shelter compartment within the interior space of the enclosure when the secondary tent is in the deployed position.

18. The tent system of claim 17, wherein the shelter compartment has a volume being less than a volume of the chamber being defined by the tent.

19. The tent system of claim 17, the secondary tent further comprising:
a top panel being slidably coupled to the plurality of braces;
a plurality of side panels being coupled to and extending downwardly from the top panel, each side panel of the plurality of side panels being perpendicular to an adjacent panel of the plurality of side panels wherein the shelter compartment is rectangular when the secondary tent is in the deployed position; and
an entryway being coupled to a side panel of the plurality of side panels, the entryway being openable to facilitate access to the shelter compartment when the secondary tent is in the deployed position.

20. A tent system comprising:
an enclosure having a ceiling, a floor, and a plurality of sides being coupled to and extending between the ceiling and the floor to define an interior space of the enclosure, the plurality of sides including a front side, a back side, and a pair of lateral sides, the front side and the back side extending between opposing lateral edges of the pair of lateral sides, said enclosure being a trailer;
a side-entry door being coupled to a first lateral side of the pair of lateral sides, the side-entry door being positioned proximate to the front side, the side-entry door being openable to facilitate access to the interior space;
a rear door being coupled to the back side of the enclosure, the rear door being openable to facilitate access to the interior space;
a plurality of braces being coupled to the pair of lateral sides of the enclosure, the plurality of braces extending between the pair of lateral sides of the enclosure, the plurality of braces being positioned adjacent to the ceiling of the enclosure, each brace of the plurality of braces being spaced from an adjacent brace of the plurality of braces by between 1.5 feet and 2.5 feet, the plurality of braces being perpendicular to the pair of lateral sides of the enclosure;
a tent being coupled to the enclosure, the tent being positioned in the interior space adjacent to the front side of the enclosure, the tent being collapsable into a storage position wherein the tent is positioned against a second lateral side of the pair of lateral sides when the tent is in the storage position, the tent being expandable into a deployed position wherein the tent defines a chamber within the interior space when the tent is in the deployed position, the tent further comprising:
a tent roof being slidably coupled to the plurality of braces, the tent roof being rectangular, the tent roof being positioned adjacent to the ceiling of the enclosure wherein the tent is configured to permit a user to stand up within the chamber when the tent is in the deployed position;
a plurality of retainers slidably coupling the tent roof to the plurality of braces, each retainer of the plurality of retainers having a curved portion and a straight portion, the curved portion being coupled to and extending between opposing lateral ends of the straight portion wherein each retainer of the plurality of retainers has a D-shape, wherein the straight portion is coupled to the tent roof and the curved portion hangs from a respective brace of the plurality of braces;
a plurality of tent walls being coupled to and extending downwardly from the tent roof toward the floor of the enclosure wherein the tent is configured to define the chamber, each tent wall of the plurality of tent walls being perpendicular to an adjacent tent wall of the plurality of tent walls wherein the chamber is rectangular when the tent is in the deployed position, the plurality of tent walls further comprising:
a first wall being positioned adjacent to the second lateral side of the pair of lateral sides of the enclosure, the first wall being parallel to the second lateral side of the enclosure;
a second wall being coupled to the first wall, the second wall being positionable proximate to the front side of the enclosure when the tent is in the deployed position;
a third wall being coupled to the second wall, the third wall being positionable proximate to the first lateral side of the pair of lateral sides of the enclosure when the tent is in the deployed position, the third wall being parallel to the first lateral side of the enclosure;
a fourth wall being coupled to the third wall and the first wall, the fourth wall being parallel to the back side of the enclosure when the tent is in the deployed position, the fourth wall being spaced from the back side of the enclosure;
a side tent door being coupled to the third wall of the plurality of tent walls, the side tent door being openable to facilitate access to the chamber, the side tent door being aligned with the side-entry door of the enclosure wherein the side tent door is configured to permit the user to enter the chamber through the side-entry door of the enclosure when the tent is in the deployed position;
a back tent door being coupled to the fourth wall of the plurality of tent walls, the back tent door being openable to facilitate access to the chamber, the back tent door being alignable with the rear door of the enclosure when the tent is in the deployed position wherein the back tent door is configured to facilitate the user in entering the chamber through the rear door of the enclosure when the tent is in the deployed position;
a side tent door fastener being coupled to the third wall of the plurality of tent walls and to the side tent door, the side tent door fastener securing the side tent door to the third wall of the plurality of tent walls to inhibit the side tent door from being opened, the side tent door fastener comprising a zipper;
a back tent door fastener being coupled to the fourth wall of the plurality of tent walls and to the back tent door, the back tent door fastener securing the back tent door to the fourth wall of the plurality of tent walls to inhibit the back tent door from being opened, the back tent door fastener comprising a zipper;
a skirting being coupled to the plurality of tent walls, the skirting extending downwardly from each tent wall of the plurality of tent walls wherein a combined height of the skirting and the plurality of tent walls exceeds a height of the plurality of tent walls, the combined height of the skirting and the plurality of tent walls exceeding a height of the enclosure;
a side tent door window being positioned on the side tent door;
a back tent door window being positioned on the back tent door;
a wall window being positioned on the fourth wall of the plurality of tent walls;
a vent extending through one of the plurality of tent walls wherein the vent is configured to facilitate airflow through the chamber;
a mesh fabric covering the vent;
a plurality of through-holes extending through one of the plurality of tent walls, the plurality of through-holes being configured to align with a plurality of apertures extending into the plurality of sides of the enclosure wherein the plurality of through-holes makes the wall of the plurality of tent walls configured to facilitate the user in hanging objects on the wall of the plurality of tent walls;
the tent roof, each of the plurality of tent walls, the side tent door, the back tent door, and the skirting of the tent comprising a fabric material, the fabric material being flexible wherein the fabric material configured to facilitate the tent being collapsed into the storage position, the fabric material being insulated wherein the fabric material is configured to insulate contents of the chamber from temperatures within the interior space of the enclosure;
a plurality of anchors securing the plurality of tent walls to the floor of the enclosure when the tent is in the deployed position, the plurality of anchors further comprising:
a plurality of straps being coupled to the plurality of tent walls, the plurality of straps extending downwardly from the plurality of tent walls;
a plurality of tie-down rings being coupled to the floor of the enclosure;
the plurality of straps being aligned with the plurality of tie-down rings when the tent is in the deployed position wherein each strap of the plurality of straps is selectively engageable to an associated tie-down ring of the plurality of tie-down rings;
a secondary tent being coupled to the enclosure, the secondary tent being positioned in the interior space proximate to the back side of the enclosure, the secondary tent being collapsable into the storage position wherein the secondary tent is positioned against the second lateral side of the pair of lateral sides of the enclosure when the secondary tent is in the storage position, the secondary tent being expandable into the deployed position wherein the secondary tent defines a shelter compartment within the interior space of the enclosure when the secondary tent is in the deployed position, the secondary tent being positioned between the back side of the enclosure and the tent, the shelter compartment having a volume being less than a volume of the chamber being defined by the tent, the secondary tent further comprising:
a top panel being slidably coupled to the plurality of braces;
the plurality of retainers slidably coupling the top panel to the plurality of braces;
a plurality of side panels being coupled to and extending downwardly from the top panel, each side panel of the plurality of side panels being perpendicular to an adjacent side panel of the plurality of side panels wherein the shelter compartment is rectangular when the secondary tent is in the deployed position, each side panel of the plurality of side panels being parallel to a respective tent wall of the plurality of tent walls when the secondary tent and the tent are each in the deployed position, the plurality of side panels further comprising:
a primary panel being positioned adjacent to the second lateral side of the pair of lateral sides of the enclosure, the primary panel being parallel to the second lateral side of the enclosure, the primary panel being parallel to the first wall of the tent;
a secondary panel being coupled to the primary panel, the secondary panel being alignable with the front side of the enclosure when the secondary tent is in the deployed position, the secondary panel being parallel to the front side of the enclosure when the secondary tent is in the deployed position, the secondary panel being parallel to the second wall of the tent, the secondary panel being spaced from the second wall of the tent;
a tertiary panel being coupled to the secondary panel, the tertiary panel being positionable against the first lateral side of the pair of lateral sides of the enclosure when the secondary tent is in the deployed position, the tertiary panel being parallel to the first lateral side of the enclosure, the tertiary panel being parallel to the third wall of the tent;
a quaternary panel being coupled to the tertiary panel and the primary panel, the quaternary panel being parallel to the back side of the enclosure when the secondary tent is in the deployed position, the quaternary panel being alignable with the back side of the enclosure when the secondary tent is in the deployed position, the quaternary panel being spaced from the back side of the enclosure, the quaternary panel being parallel to the fourth wall of the tent, the quaternary panel being spaced from the fourth wall of the tent;
each panel of the plurality of side panels having a width being smaller than a width of the plurality of tent walls whereby the volume of shelter compartment defined by the secondary tent is less than the volume of the chamber defined by the tent;
a side entryway being positioned on the tertiary panel of the plurality of side panels, the side entryway being openable to facilitate access to the shelter compartment through the side-entry door of the enclosure when the secondary tent is in the deployed position;
a back entryway being positioned on the quaternary panel of the plurality of side panels, the back entryway being openable to facilitate access to the shelter compartment through the rear door of the enclosure when the secondary tent is in the deployed position;
a side entryway fastener being coupled to the tertiary panel of the plurality of side panels and to the side entryway, the side entryway fastener securing the side entryway to the tertiary panel to inhibit the side entryway from being opened, the side entryway fastener comprising a zipper;
a back entryway fastener being coupled to the quaternary panel of the plurality of side panels and to the back entryway, the back entryway fastener securing the back entryway to the quaternary panel to inhibit the back entryway from being opened, the back entryway fastener comprising a zipper;
a trim being coupled to the plurality of side panels, the trim extending downwardly from each side panel of the plurality of side panels wherein a combined height of the trim and the plurality of side panels exceeds a height of the plurality of side panels, the combined height of the trim and the plurality of side panels exceeding a height of the enclosure;
a window panel being coupled to the side entryway, the window panel comprising the transparent material wherein the window panel is configured to facilitate the user in looking through the window panel;
a cutout extending through one of the plurality of side panels wherein the cutout is configured to facilitate airflow through the shelter compartment;
the mesh fabric covering the cutout;
the top panel, the plurality of side panels, the side entryway, the back entryway, and the trim of the secondary tent comprising the fabric material, the fabric material being flexible wherein the fabric material is configured to facilitate the secondary tent being collapsed into the storage position, the fabric material being insulated wherein the fabric material is configured to insulate contents of the shelter compartment from temperatures within the interior space of the enclosure; and
the plurality of anchors securing the plurality of side panels to the floor of the enclosure when the secondary tent is in the deployed position.
